(19) United States
(12) Patent Application Publication
(10) Pub. No.: US 2015/0109253 A1
(43) Pub. Date: Apr. 23, 2015

(54) Touch Positioning Method and Apparatus, and Touch Screen Terminal

(71) Applicant: Huawei Device Co., Ltd., Shenzhen (CN)

(72) Inventor: Huangwei Wu, Shenzhen (CN)

(21) Appl. No.: 14/586,601

(22) Filed: Dec. 30, 2014

Related U.S. Application Data
(63) Continuation of application No. PCT/CN2013/077436, filed on Jun. 19, 2013.

(30) Foreign Application Priority Data
Dec. 28, 2012 (CN) 201210587008.3

(51) Int. Cl. G06F 3/041; G06F 3/044

(52) U.S. Cl. CPC G06F 3/0418; G06F 3/044
USPC 345/174

(57) ABSTRACT

Embodiments of the present invention disclose a touch positioning method and apparatus, and a touch screen terminal, where the method includes: recording first track information about moving of a contact point on a touchscreen; determining, from the first track information, second track information that is before a process in which the contact point leaves the touchscreen; and positioning, according to the second track information, a position at which the contact point leaves the touchscreen. In the embodiments of the present invention, a position of a contact point can be accurately positioned according to track information that is before a process in which the contact point leaves a touch screen, so that accuracy of terminal positioning is improved and user experience of a user using a touch screen terminal is enhanced

This application claims the benefit of International Application No. PCT/CN2013/077436, filed on Jun. 19, 2013, which claims priority to Chinese Patent Application No. 201210587008.3, filed on Dec. 28, 2012, which applications are hereby incorporated by reference.

### TECHNICAL FIELD

The present invention relates to the field of communications technologies, and in particular, to a touch positioning method and apparatus, and a touch screen terminal.

### BACKGROUND

With the development of an intelligent terminal, a capacitive touch screen is widely used on the intelligent terminal as a display and input component of the intelligent terminal. A transparent thin-film conductor layer is plated on a surface layer of the capacitive touch screen; long and narrow electrodes are plated on four sides of the touch screen; and a low-voltage alternating electric field is formed in the thin-film conductor layer. When a user's finger is in contact with the touch screen, because of existence of a human electric field, a coupling capacitor is formed at a position of a contact point between the finger and the thin-film conductor layer, and currents emitted from the electrodes on the four sides flow to the contact point. Because current intensity is proportional to a distance between the finger and an electrode, the terminal can calculate a proportion and intensity of a current, so as to obtain a position of the contact point on the touch screen.

However, in the prior art, compared with a contact area of the finger on the touch screen when the finger taps the touch screen, in a process in which the user's finger leaves the touch screen, the contact area of the finger on the touch screen unevenly deforms in various directions, so that a tapping position obtained by calculation by a controller according to track information in the process in which the finger leaves the touch screen deviates from an actual tapping position that is before the finger leaves the touch screen, thereby causing inaccurate terminal positioning.

### SUMMARY

Embodiments of the present invention provide a touch positioning method and apparatus, and a touch screen terminal, so as to solve a problem in the prior art that terminal positioning is inaccurate when a user's finger leaves a touch screen.

To solve the foregoing technical problem, the embodiments of the present invention disclose the following technical solutions:

According to a first aspect, a touch positioning method is provided, where the method includes:

recording first track information about moving of a contact point on a touch screen;

determining, from the first track information, second track information that is before a process in which the contact point leaves the touch screen; and

positioning, according to the second track information, a position at which the contact point leaves the touch screen.

With reference to the first aspect, in a first possible implementation manner of the first aspect, the first track information includes at least one of the following information:

information about a position at each sampling time point when the contact point moves on the touch screen; and

a contact range at each sampling time point when the contact point moves on the touch screen.

With reference to the first possible implementation manner of the first aspect, in a second possible implementation manner of the first aspect, the determining, from the first track information, second track information that is before a process in which the contact point leaves the touch screen specifically is:

when the first track information includes the information about the position at each sampling time point, acquiring, from the first track information, information about a position at each sampling time point in a first time period that is before the contact point leaves the touch screen, and using information about a position of the contact point at a sampling time point that is before the first time period as the second track information that is before the process in which the contact point leaves the touch screen; and

the positioning, according to the second track information, a position at which the contact point leaves the touch screen specifically is:

determining the position of the contact point at the sampling time point that is before the first time period as the position at which the contact point leaves the touch screen.

With reference to the first possible implementation manner of the first aspect, in a third possible implementation manner of the first aspect, the determining, from the first track information, second track information that is before a process in which the contact point leaves the touch screen specifically is:

when the first track information includes the contact range at each sampling time point, acquiring, from the first track information, a contact range at each sampling time point in a second time period that is before the contact point leaves the touch screen, and using a contact range of the contact point at a sampling time point that is before the second time period as the second track information that is before the process in which the contact point leaves the touch screen; and

the positioning, according to the second track information, a position at which the contact point leaves the touch screen specifically is:

calculating a position according to the contact range of the contact point at the sampling time point that is before the second time period, and determining the position obtained by calculation as the position at which the contact point leaves the touch screen.

With reference to the first possible implementation manner of the first aspect, in a fourth possible implementation manner of the first aspect, the determining, from the first track information, second track information that is before a process in which the contact point leaves the touch screen specifically is:

when the first track information includes the information about the position at each sampling time point and the contact range at each sampling time point, acquiring, from the first track information, a contact range at each sampling time point in a second time period that is before the contact point leaves the touch screen, and using a contact range of the contact point at a sampling time point that is before the second time period as the second track information that is before the process in which the contact point leaves the touch screen; and

the positioning, according to the second track information, a position at which the contact point leaves the touch screen specifically is:

determining a position corresponding to the contact range of the contact point at the sampling time point that is before the second time period as the position at which the contact point leaves the touch screen.

According to a second aspect, a touch positioning apparatus is provided, where the apparatus includes:

recording unit, configured to record first track information about moving of a contact point on a touch screen;

a determining unit, configured to determine, from the first track information recorded by the recording unit, second track information that is before a process in which the contact point leaves the touch screen; and

a positioning unit, configured to position, according to the second track information determined by the determining unit, a position at which the contact point leaves the touch screen.

With reference to the second aspect, in a first possible implementation manner of the second aspect, the first track information recorded by the recording unit includes at least one of the following information:

information about a position at each sampling time point when the contact point moves on the touch screen; and

a contact range at each sampling time point when the contact point moves on the touch screen.

With reference to the first possible implementation manner of the second aspect, in a second possible implementation manner of the second aspect, the first track information recorded by the recording unit includes the information about the position at each sampling time point;

the determining unit is specifically configured to acquire, from the first track information recorded by the recording unit, information about a position at each sampling time point in a first time period that is before the contact point leaves the touch screen, and use information about a position of the contact point at a sampling time point that is before the first time period as the second track information that is before the process in which the contact point leaves the touch screen; and

the positioning unit is specifically configured to determine the position of the contact point at the sampling time point that is before the first time period as the position at which the contact point leaves the touch screen, where the position of the contact point at the sampling time point that is before the first time period is determined by the determining unit.

With reference to the first possible implementation manner of the second aspect, in a third possible implementation manner of the second aspect,

the first track information recorded by the recording unit includes the contact range at each sampling time point;

the determining unit is specifically configured to acquire, from the first track information recorded by the recording unit, a contact range at each sampling time point in a second time period that is before the contact point leaves the touch screen, and use a contact range of the contact point at a sampling time point that is before the second time period as the second track information that is before the process in which the contact point leaves the touch screen; and

the positioning unit is specifically configured to calculate a position according to the contact range of the contact point at the sampling time point that is before the second time period, and determine the position obtained by calculation as the position at which the contact point leaves the touch screen, where the contact range of the contact point at the sampling time point that is before the second time period is determined by the determining unit.

With reference to the first possible implementation manner of the second aspect, in a fourth possible implementation manner of the second aspect,

the first track information recorded by the recording unit includes the information about the position at each sampling time point and the contact range at each sampling time point;

the determining unit is specifically configured to acquire, from the first track information recorded by the recording unit, a contact range at each sampling time point in a second time period that is before the contact point leaves the touch screen, and use a contact range of the contact point at a sampling time point that is before the second time period as the second track information that is before the process in which the contact point leaves the touch screen; and

the positioning unit is specifically configured to determine a position corresponding to the contact range of the contact point at the sampling time point that is before the second time period as the position at which the contact point leaves the touch screen, where the contact range of the contact point at the sampling time point that is before the second time period is determined by the determining unit.

According to a third aspect, a touch screen terminal is provided, where the touch screen terminal includes: a bus, and a touch screen, a memory, and a processor that are connected by using the bus, where:

the memory is configured to record first track information about moving of a contact point on the touch screen; and

the processor is configured to determine, from the first track information recorded by the memory, second track information that is before a process in which the contact point leaves the touch screen, and position, according to the second track information, a position at which the contact point leaves the touch screen.

With reference to the third aspect, in a first possible implementation manner of the third aspect,

the first track information recorded by the memory includes information about a position at each sampling time point when the contact point moves on the touch screen; and

the processor is specifically configured to acquire, from the first track information recorded by the memory, information about a position at each sampling time point in a first time period that is before the contact point leaves the touch screen, and determine a position of the contact point at a sampling time point that is before the first time period as the position at which the contact point leaves the touch screen.

With reference to the third aspect, in a second possible implementation manner of the third aspect,

the first track information recorded by the memory includes a contact range at each sampling time point when the contact point moves on the touch screen; and

the processor is specifically configured to acquire, from the first track information recorded by the memory, a contact range at each sampling time point in a second time period that is before the contact point leaves the touch screen, calculate a position according to a contact range of the contact point at a sampling time point that is before the second time period, and determine the position obtained by calculation as the position at which the contact point leaves the touch screen.

With reference to the third aspect, in a third possible implementation manner of the third aspect,

the first track information recorded by the memory includes information about a position at each sampling time point and a contact range at each sampling time point when the contact point moves on the touch screen; and

the processor is specifically configured to acquire, from the first track information recorded by the memory, a contact range at each sampling time point in a second time period that is before the contact point leaves the touch screen, and determine a position corresponding to a contact range of the contact point at a sampling time point that is before the second time period as the position at which the contact point leaves the touchscreen.

In the embodiments of the present invention, first track information about moving of a contact point on a touchscreen is recorded; second track information that is before a process in which the contact point leaves the touchscreen is determined from the first track information; and a position at which the contact point leaves the touchscreen is positioned according to the second track information. Because track information that is before the process in which the contact point leaves the touchscreen indicates an actual tapping position that is before a finger leaves the touchscreen, in the embodiments of the present invention, a position of the contact point can be accurately positioned according to the track information that is before the process in which the contact point leaves the touchscreen, so that accuracy of terminal positioning is improved and user experience of a user using a touch screen terminal is enhanced.

### BRIEF DESCRIPTION OF THE DRAWINGS

To describe the technical solutions in the embodiments of the present invention more clearly, the following briefly introduces the accompanying drawings required for describing the embodiments. Apparently, a person of ordinary skill in the art may still derive other drawings from these accompanying drawings without creative efforts.

FIG. 1A is a flowchart of a touch positioning method according to an embodiment of the present invention;

FIG. 1B is a schematic diagram of track information at a sampling time point according to an embodiment of the present invention;

FIG. 2 is a flowchart of a touch positioning method according to another embodiment of the present invention;

FIG. 3 is a flowchart of a touch positioning method according to another embodiment of the present invention;

FIG. 4 is a flowchart of a touch positioning method according to another embodiment of the present invention;

FIG. 5 is a block diagram of a touch positioning apparatus according to an embodiment of the present invention; and

FIG. 6 is a block diagram of a touch screen terminal according to an embodiment of the present invention.

### DETAILED DESCRIPTION OF ILLUSTRATIVE EMBODIMENTS

The following embodiments of the present invention provide a touch positioning method and apparatus, and a touch screen terminal.

To enable a person skilled in the art to better understand the technical solutions of the embodiments of the present invention and to make the foregoing objectives, features, and advantages of the embodiments of the present invention more obvious and comprehensible, the following describes the technical solutions of the embodiments of the present invention in further detail with reference to the accompanying drawings.

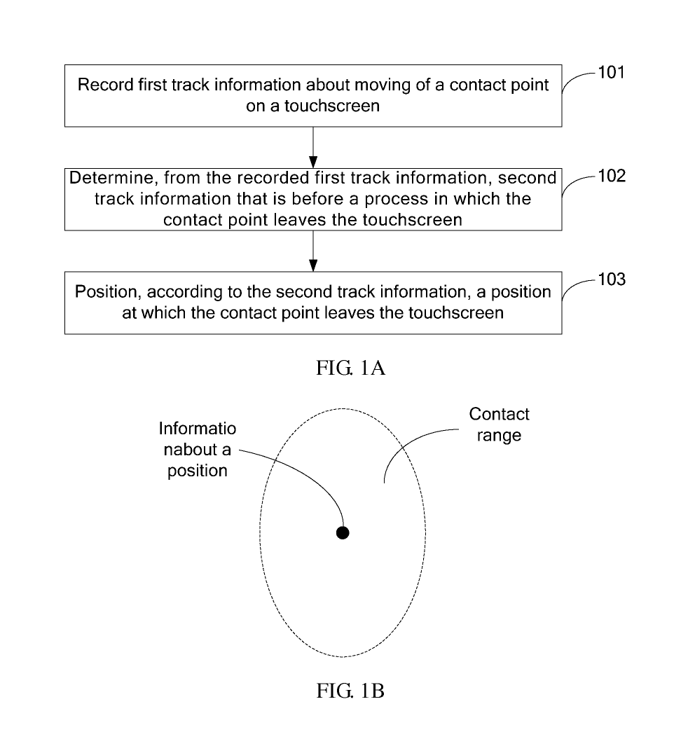

Referring to FIG. 1A, FIG. 1A is a flowchart of an embodiment of a touch positioning method according to the present invention.

Step 101: Record first track information about moving of a contact point on a touchscreen.

In this embodiment, the first track information about the moving of the contact point on the touchscreen may include: information about a position at each sampling time point when the contact point moves on the touchscreen, or a contact range at each sampling time point when the contact point moves on the touch screen, or information about a position and a contact range at each sampling time point when the contact point moves on the touchscreen.

A terminal using this method embodiment of the present invention usually has a capacitive touchscreen. When a user's finger is in contact with the touch screen, a contact point is formed on the touchscreen; a contact range of the contact point on the touch screen can be obtained according to a coupling capacitor formed on the contact point; and a position of the contact point in the contact range can further be calculated according to the contact range, where the calculating the position of the contact point according to the contact range may use a calculation manner in the prior art, which is not repeatedly described in this embodiment of the present invention.

As shown in FIG. 1B, FIG. 1B shows a schematic diagram of track information at a sampling time point. An oval area is a contact range of the contact point on the touchscreen at a sampling time point, and a round dot in a center of the oval area indicates the information that is about the position of the contact point and is determined according to the contact range.

Step 102: Determine, from the recorded first track information, second track information that is before a process in which the contact point leaves the touchscreen.

In this embodiment, when it is determined that the contact point leaves the touchscreen, track information that is before the process in which the contact point leaves the touchscreen may be found from the recorded first track information. When it is determined whether the contact point leaves the touch screen, the terminal may detect whether there is a coupling capacitor between the contact point and the touchscreen. When there is no coupling capacitor between the contact point and the touchscreen, it may be determined that the contact point has left the touch screen.

Optionally, when the recorded first track information includes the information about the position at each sampling time point, information about a position at each sampling time point in a first time period that is before the contact point leaves the touchscreen may be acquired from the recorded first track information, and information about a position of the contact point at a sampling time point that is before the first time period is used as the second track information that is before the process in which the contact point leaves the touchscreen.

Optionally, when the recorded first track information includes the contact range at each sampling time point, a contact range at each sampling time point in a second time period that is before the contact point leaves the touchscreen may be acquired from the recorded first track information, and a contact range of the contact point at a sampling time point that is before the second time period is used as the second track information that is before the process in which the contact point leaves the touchscreen.

Step 103: Position, according to the second track information, a position at which the contact point leaves the touchscreen.

Optionally, when the first track information recorded in step 101 includes the information about the position at each sampling time point, and when the information about the position at each sampling time point in the first time period that is before the contact point leaves the touchscreen is acquired from the first track information in step 102, the position of the contact point at the sampling time point that is before the first time period may be determined as the position at which the contact point leaves the touchscreen.

Optionally, when the first track information recorded in step 101 includes the contact range at each sampling time point, and when the contact range at each sampling time point in the second time period that is before the contact point leaves the touchscreen is acquired from the first track information in step 102, a position may be calculated according to the contact range of the contact point at the sampling time point that is before the second time period, and the position obtained by calculation is determined as the position at which the contact point leaves the touchscreen.

Optionally, when the first track information recorded in step 101 includes the information about the position and the contact range at each sampling time point, and when the contact range at each sampling time point in the second time period that is before the contact point leaves the touchscreen is acquired from the first track information in step 102, a position corresponding to the contact range of the contact point at the sampling time point that is before the second time period may be determined as the position at which the contact point leaves the touchscreen.

It can be seen from the foregoing embodiment that, because track information that is before a process in which a contact point leaves a touchscreen indicates an actual tapping position that is before a finger leaves the touchscreen, in this embodiment of the present invention, a position of the contact point can be accurately positioned according to the track information that is before the process in which the contact point leaves the touchscreen, so that accuracy of terminal positioning is improved and user experience of a user using a touch screen terminal is enhanced.

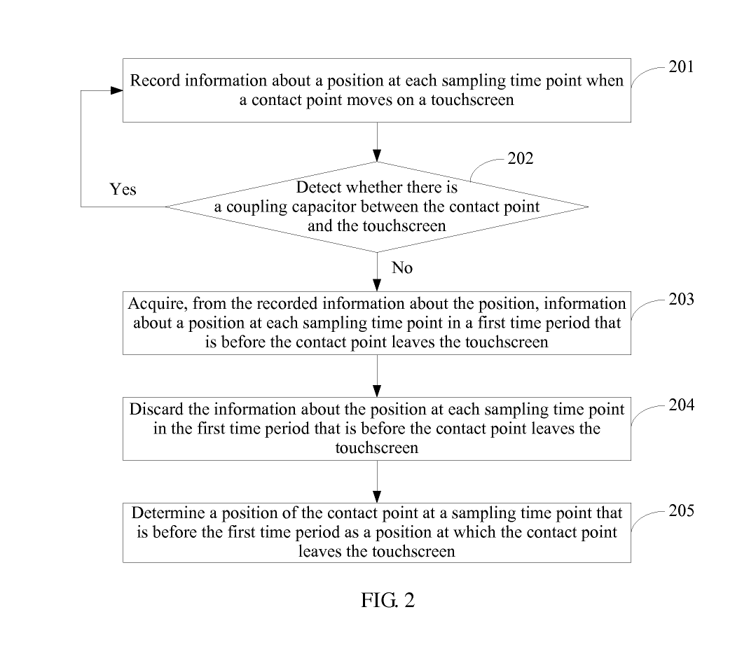

Referring to FIG. 2, FIG. 2 is a flowchart of another embodiment of a touch positioning method according to the present invention.

Step 201: Record information about a position at each sampling time point when a contact point moves on a touchscreen.

A terminal using this method embodiment of the present invention usually has a capacitive touchscreen. When a user's finger is in contact with the touch screen, a contact point is formed on the touchscreen; a contact range of the contact point on the touch screen can be obtained according to a coupling capacitor formed on the contact point; and a position of the contact point in the contact range can further be calculated according to the contact range. In this embodiment, the position, of the contact point, is obtained by calculation according to the contact range may be recorded.

Step 202: Detect whether there is a coupling capacitor between the contact point and the touchscreen. If there is a coupling capacitor between the contact point and the touch screen, return to step 201; if there is no coupling capacitor between the contact point and the touch screen, perform step 203.

Step 203: Acquire, from the recorded information about the position, information about a position at each sampling time point in a first time period that is before the contact point leaves the touchscreen.

When there is no coupling capacitor between the contact point and the touchscreen, it is determined that the contact point has left the touchscreen.

In this embodiment, the first time period is approximate time required in a process in which the contact point leaves the touchscreen, and the time is time obtained according to a user's common touch habit, for example, the time may be set to 0.2 s. In an actual application process, the first time period may be preset by a terminal, and may also be set by a user by adjustment, which is not limited in this embodiment of the present invention.

Step 204: Discard the information about the position at each sampling time point in the first time period that is before the contact point leaves the touchscreen.

Because the information about the position at each sampling time point in the first time period that is before the contact point leaves the touch screen deviates from information about an actual position of the contact point, in this embodiment of the present invention, the information about the position at each sampling time point in the first time period that is before the contact point leaves the touchscreen may be discarded. In addition, because the information about the position is usually recorded in a cache of the terminal, discarding the information about the position at each sampling time point in the first time period can save cache space.

Step 205: Determine a position of the contact point at a sampling time point that is before the first time period as a position at which the contact point leaves the touchscreen.

Because the actual position of the contact point may accurately be positioned according to a position information that is before the process in which the contact point leaves the touch screen, in this embodiment, a position recorded at a sampling time point that is before the first time period may be determined as the position at which the contact point leaves the touchscreen. For example, 0.5 s is totally used from coming into contact with the touch screen to leaving the touchscreen by the contact point, where every 0.1 s is a sampling time point, and the terminal totally records positions of the contact point at 0.1 s, 0.2 s, 0.3 s, and 0.4 s. When the first time period is 0.2 s, the first time period includes 0.3 s and 0.4, then a sampling time point that is before the first time period is 0.2 s, and the recorded position at 0.2 s is determined as the position at which the contact point leaves the touchscreen.

It can be seen from the foregoing embodiment that, because track information that is before a process in which a contact point leaves a touchscreen indicates an actual tapping position that is before a finger leaves the touchscreen, in this embodiment of the present invention, a position of the contact point can be accurately positioned according to the track information that is before the process in which the contact point leaves the touchscreen, so that accuracy of terminal positioning is improved and user experience of a user using a touch screen terminal is enhanced.

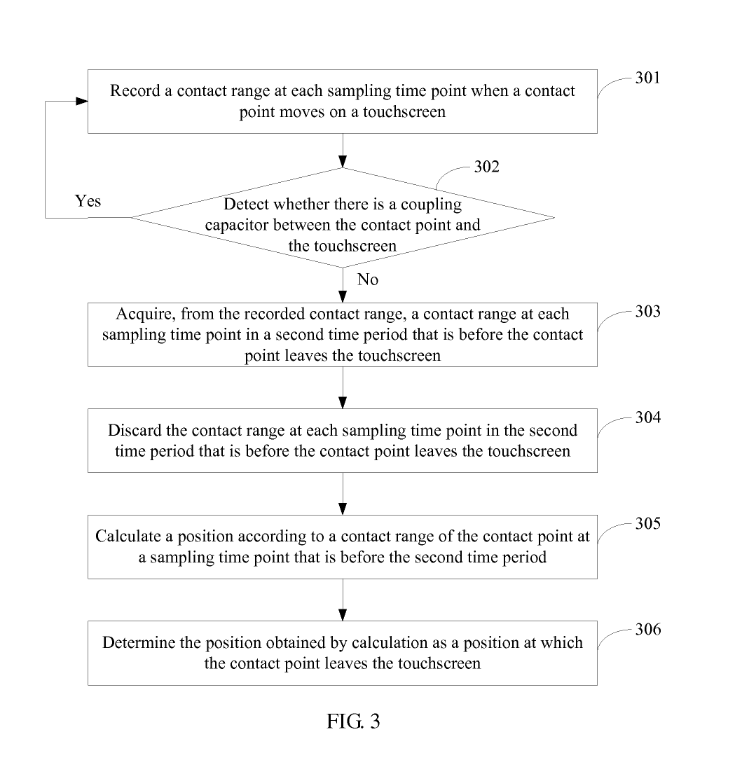

Referring to FIG. 3, FIG. 3 is a flowchart of another embodiment of a touch positioning method according to the present invention.

Step 301: Record a contact range at each sampling time point when a contact point moves on a touch screen.

A terminal using this method embodiment of the present invention usually has a capacitive touchscreen. When a user's finger is in contact with the touch screen, a contact point is formed on the touchscreen, and a contact range of the contact point on the touch screen can be obtained according to a coupling capacitor formed on the contact point. In this embodiment, the obtained contact range of the contact point on the touchscreen may be recorded.

Step 302: Detect whether there is a coupling capacitor between the contact point and the touchscreen. If there is a coupling capacitor between the contact point and the touch screen, return to step 301; if there is no coupling capacitor between the contact point and the touchscreen, perform step 303.

Step 303: Acquire, from the recorded contact range, a contact range at each sampling time point in a second time period that is before the contact point leaves the touchscreen.

When there is no coupling capacitor between the contact point and the touchscreen, it is determined that the contact point has left the touchscreen.

In this embodiment, the second time period is time during which the contact range continuously changes in a process in which the contact point leaves the touchscreen. For example, a contact range recorded in 0.5 s that is before the contact point leaves the touchscreen continuously becomes smaller, and then it indicates that the 0.5 s process is the process in which the contact point leaves the touch screen.

Step 304: Discard the contact range at each sampling time point in the second time period that is before the contact point leaves the touchscreen.

Because the contact range at each sampling time point in the second time period that is before the contact point leaves the touch screen deviates from a contact range corresponding to information about an actual position of the contact point, in this embodiment of the present invention, the contact range at each sampling time point in the second time period that is before the contact point leaves the touchscreen may be discarded. In addition, because the contact range is usually recorded in a cache of the terminal, discarding the contact range at each sampling time point in the second time period can save cache space.

Step 305: Calculate a position according to a contact range of the contact point at a sampling time point that is before the second time period.

Because the actual position of the contact point may accurately be positioned according to a contact range of the contact point that is before the process in which the contact point leaves the touch screen, in this embodiment, the position may be calculated according to a contact range of the contact point at a sampling time point that is before the second time period. For example, 0.9 s is totally used from coming into contact with the touch screen to leaving the touchscreen by the contact point, where every 0.1 s is a sampling time point, and the terminal totally records contact ranges of the contact point on the touchscreen at 0.1 s, 0.2 s, 0.3 s, 0.4 s, 0.5 s, 0.6 s, 0.7 s, 0.8 s, and 0.9 s. If a contact range in 0.5 s that is before the contact point leaves the touchscreen continuously becomes smaller, it may be determined that a contact range recorded at a sampling time point that is before the 0.5 s, that is, at 0.4 s, is a contact range corresponding to a position at which the contact point leaves the touch screen, and a position of the contact point at 0.4 s may be calculated according to the contact range.

Step 306: Determine the position obtained by calculation as a position at which the contact point leaves the touchscreen.

It can be seen from the foregoing embodiment that, because track information that is before a process in which a contact point leaves a touchscreen indicates an actual tapping position that is before a finger leaves the touchscreen, in this embodiment of the present invention, a position of the contact point can be accurately positioned according to the track information that is before the process in which the contact point leaves the touchscreen, so that accuracy of terminal positioning is improved and user experience of a user using a touch screen terminal is enhanced.

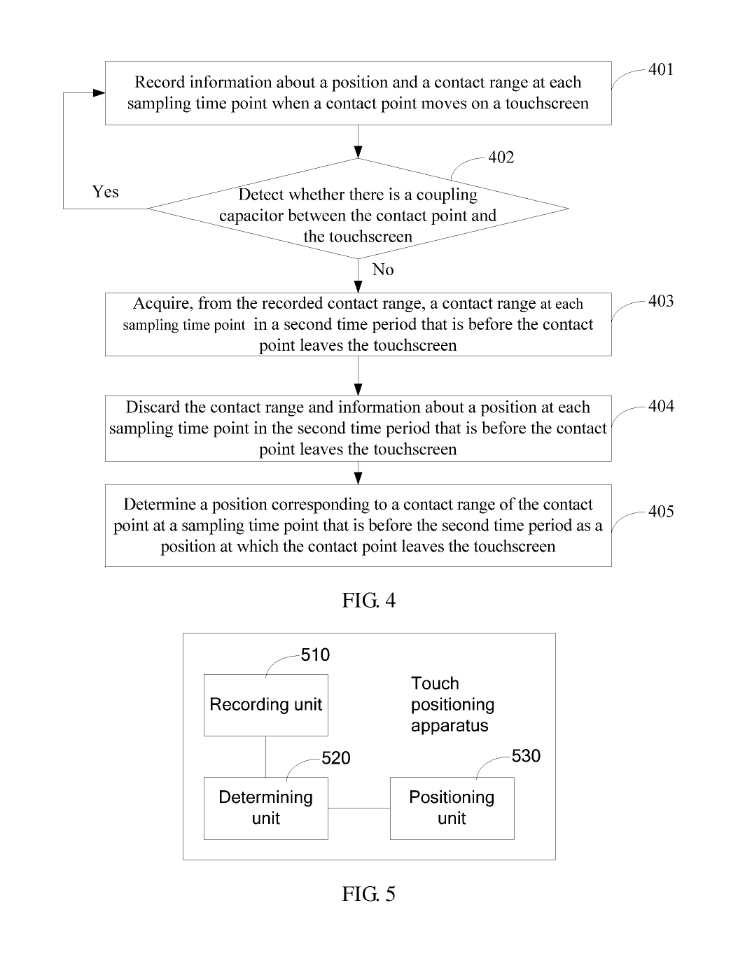

Referring to FIG. 4, FIG. 4 is a flowchart of another embodiment of a touch positioning method according to the present invention.

Step 401: Record information about a position and a contact range at each sampling time point when a contact point moves on a touchscreen.

A terminal using this method embodiment of the present invention usually has a capacitive touchscreen. When a user's finger is in contact with the touch screen, a contact point is formed on the touchscreen; a contact range of the contact point on the touch screen can be obtained according to a coupling capacitor formed on the contact point; and a position of the contact point in the contact range can further be calculated according to the contact range. In this embodiment, the obtained contact range of the contact point on the touch screen, and the position, of the contact point, obtained by calculation according to the contact range may be recorded.

Step 402: Detect whether there is a coupling capacitor between the contact point and the touchscreen. If there is a coupling capacitor between the contact point and the touch screen, return to step 401; if there is no coupling capacitor between the contact point and the touch screen, perform step 403.

Step 403: Acquire, from the recorded contact range, a contact range at each sampling time point in a second time period that is before the contact point leaves the touch screen.

When there is no coupling capacitor between the contact point and the touchscreen, it is determined that the contact point has left the touchscreen.

In this embodiment, the second time period is time during which the contact range continuously changes in a process in which the contact point leaves the touchscreen. For example, a contact range recorded in 0.5 s that is before the contact point leaves the touchscreen continuously becomes smaller, and then it indicates that the 0.5 s process is the process in which the contact point leaves the touchscreen.

Step 404: Discard the contact range and information about a position at each sampling time point in the second time period that is before the contact point leaves the touchscreen.

Because the contact range at each sampling time point in the second time period that is before the contact point leaves the touch screen deviates from a contact range corresponding to information about an actual position of the contact point, in this embodiment of the present invention, the contact range and the information about the position at each sampling time point in the second time period that is before the contact point leaves the touchscreen may be discarded. In addition, because the contact range and the information about the position are usually recorded in a cache of the terminal, discarding the contact range and the information about the position at each sampling time point in the second time period can save cache space.

Step 405: Determine a position corresponding to a contact range of the contact point at a sampling time point that is before the second time period as a position at which the contact point leaves the touchscreen.

In this embodiment, because the contact range and the information about the position of the contact point at each sampling time point are recorded, once after a contact range of the contact point at a sampling time point that is before the second time period is obtained, a position corresponding to the contact range may be obtained, and the position is determined as the position at which the contact point leaves the touchscreen.

It can be seen from the foregoing embodiment that, because track information that is before a process in which a contact point leaves a touchscreen indicates an actual tapping position that is before a finger leaves the touchscreen, in this embodiment of the present invention, a position of the contact point can be accurately positioned according to the track information that is before the process in which the contact point leaves the touchscreen, so that accuracy of terminal positioning is improved and user experience of a user using a touch screen terminal is enhanced.

Corresponding to the embodiments of the touch positioning method according to the present invention, the present invention further provides embodiments of a touch positioning apparatus and a touch screen terminal.

Referring to FIG. 5, FIG. 5 is a block diagram of an embodiment of a touch positioning apparatus according to the present invention.

The apparatus includes a recording unit 510, a determining unit 520, and a positioning unit 530.

The recording unit 510 is configured to record first track information about moving of a contact point on a touchscreen;

the determining unit 520 is configured to determine, from the first track information recorded by the recording unit 510, second track information that is before a process in which the contact point leaves the touchscreen; and

the positioning unit 530 is configured to position, according to the second track information determined by the determining unit 520, a position at which the contact point leaves the touchscreen.

Optionally, the first track information recorded by the recording unit 510 includes at least one of the following information:

information about a position at each sampling time point when the contact point moves on the touch screen; and

a contact range at each sampling time point when the contact point moves on the touchscreen.

In a first specific embodiment:

the first track information recorded by the recording unit 510 includes the information about the position at each sampling time point;

the determining unit 520 is specifically configured to acquire, from the first track information recorded by the recording unit 510, information about a position at each sampling time point in a first time period that is before the contact point leaves the touchscreen, and use information about a position of the contact point at a sampling time point that is before the first time period as the second track information that is before the process in which the contact point leaves the touchscreen; and

the positioning unit 530 is specifically configured to determine the position of the contact point at the sampling time point that is before the first time period as the position at which the contact point leaves the touch screen, where the position of the contact point at the sampling time point that is before the first time period is determined by the determining unit 520.

In a second specific embodiment:

the first track information recorded by the recording unit 510 includes the contact range at each sampling time point;

the determining unit 520 is specifically configured to acquire, from the first track information recorded by the recording unit 510, a contact range at each sampling time point in a second time period that is before the contact point leaves the touchscreen, and use a contact range of the contact point at a sampling time point that is before the second time period as the second track information that is before the process in which the contact point leaves the touchscreen; and

the positioning unit 530 is specifically configured to calculate a position according to the contact range of the contact point at the sampling time point that is before the second time period, and determine the position obtained by calculation as the position at which the contact point leaves the touchscreen, where the contact range of the contact point at the sampling time point that is before the second time period is determined by the determining unit 520.

In a third specific embodiment:

the first track information recorded by the recording unit 510 includes the information about the position at each sampling time point and the contact range at each sampling time point;

the determining unit 520 is specifically configured to acquire, from the first track information recorded by the recording unit 510, a contact range at each sampling time point in a second time period that is before the contact point leaves the touchscreen, and use a contact range of the contact point at a sampling time point that is before the second time period as the second track information that is before the process in which the contact point leaves the touchscreen; and

the positioning unit 530 is specifically configured to determine a position corresponding to the contact range of the contact point at the sampling time point that is before the second time period as the position at which the contact point leaves the touchscreen, where the contact range of the contact point at the sampling time point that is before the second time period is determined by the determining unit 520.

Optionally, the foregoing touch positioning apparatus may further include a discarding unit (not shown in FIG. 5), configured to, after the determining unit 520 determines the second track information, discard the first track information recorded in the recording unit 510.

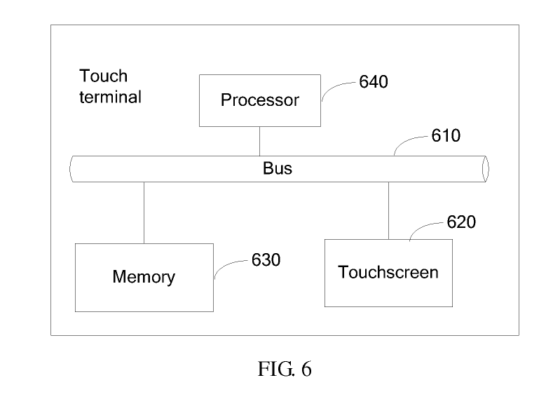

Referring to FIG. 6, FIG. 6 is a block diagram of an embodiment of a touch screen terminal according to the present invention.

The touch screen terminal includes a bus 610, and a touchscreen 620, a memory 630, and a processor 640 that are connected by using the bus 610.

The memory 630 is configured to record first track information about moving of a contact point on the touch screen 620; and

the processor 640 is configured to determine, from the first track information recorded by the memory 630, second track information that is before a process in which the contact point leaves the touchscreen 620, and position, according to the second track information, a position at which the contact point leaves the touchscreen 620.

Further, the processor 640 may further be configured to discard the first track information recorded in the memory 630.

In a first specific embodiment:

the first track information recorded by the memory 630 includes information about a position at each sampling time point when the contact point moves on the touchscreen 620; and

the processor 640 is specifically configured to acquire, from the first track information recorded by the memory 630, information about a position at each sampling time point in a first time period that is before the contact point leaves the touchscreen 620, and determine a position of the contact point at a sampling time point that is before the first time period as the position at which the contact point leaves the touchscreen 620.

In a second specific embodiment:

the first track information recorded by the memory 630 includes a contact range at each sampling time point when the contact point moves on the touchscreen 620; and

the processor 640 is specifically configured to acquire, from the first track information recorded by the memory 630, a contact range at each sampling time point in a second time period that is before the contact point leaves the touch screen 620, calculate a position according to a contact range of the contact point at a sampling time point that is before the second time period, and determine the position obtained by calculation as the position at which the contact point leaves the touchscreen 620.

In a third specific embodiment:

the first track information recorded by the memory 630 includes information about a position at each sampling time point and a contact range at each sampling time point when the contact point moves on the touchscreen 620; and

the processor 640 is specifically configured to acquire, from the first track information recorded by the memory 630, a contact range at each sampling time point in a second time period that is before the contact point leaves the touch screen 620, and determine a position corresponding to a contact range of the contact point at a sampling time point that is before the second time period as the position at which the contact point leaves the touchscreen 620.

It can be seen from the foregoing embodiment that, in this embodiment, first track information about moving of a contact point on a touchscreen is recorded; second track information that is before a process in which the contact point leaves the touchscreen is determined from the first track information; and a position at which the contact point leaves the touchscreen is positioned according to the second track information. Because track information that is before the process in which the contact point leaves the touchscreen indicates an actual tapping position that is before a finger leaves the touchscreen, in this embodiment of the present invention, a position of the contact point can be accurately positioned according to the track information that is before the process in which the contact point leaves the touchscreen, so that accuracy of terminal positioning is improved and user experience of a user using a touch screen terminal is enhanced.

A person skilled in the art may clearly understand that, the technologies in the embodiments of the present invention may be implemented by software in addition to a necessary general hardware platform. Based on such an understanding, the technical solutions of the present invention essentially or the part contributing to the prior art may be implemented in a form of a software product. The software product is stored in a storage medium, such as a ROM/RAM, a hard disk, or an optical disc, and includes several instructions for instructing a computer device (which may be a personal computer, a server, or a network device) to perform the methods described in the embodiments or some parts of the embodiments of the present invention.

The embodiments in this specification are all described in a progressive manner, for same or similar parts in the embodiments, reference may be made to these embodiments, and each embodiment focuses on a difference from other embodiments. Especially, the system embodiment is basically similar to the method embodiment, and therefore is described briefly; for related parts, reference may be made to partial descriptions in the method embodiment.

The foregoing descriptions are implementation manners of the present invention, but are not intended to limit the protection scope of the present invention. Any modification, equivalent replacement, and improvement made within the spirit and principle of the present invention shall fall within the protection scope of the present invention.

What is claimed is:

1. A touch positioning method, comprising:
recording first track information about moving of a contact point on a touchscreen;
determining, from the first track information and before a process in which the contact point leaves the touchscreen, second track information; and
positioning, according to the second track information, a position at which the contact point leaves the touchscreen.

2. The method according to claim 1, wherein the first track information comprises at least one of information about a position at each sampling time point when the contact point moves on the touchscreen and a contact range at each sampling time point when the contact point moves on the touchscreen.

3. The method according to claim 2, wherein the determining the second track information comprises:
acquiring, from the first track information and when the first track information comprises the information about the position at each sampling time point, information about a position at each sampling time point in a first time period that is before the contact point leaves the touchscreen, and using information about a position of the contact point at a sampling time point that is before the first time period as the second track information that is before the contact point leaves the touchscreen; and
wherein the positioning the position at which the contact point leaves the touchscreen comprises determining the position of the contact point at the sampling time point that is before the first time period as the position at which the contact point leaves the touchscreen.

4. The method according to claim 2, wherein the determining the second track information comprises:
acquiring, from the first track information and when the first track information comprises the contact range at each sampling time point, a contact range at each sampling time point in a second time period that is before the contact point leaves the touchscreen, and using a contact range of the contact point at a sampling time point that is before the second time period as the second track information that is before the process in which the contact point leaves the touchscreen; and
wherein the positioning the position at which the contact point leaves the touchscreen specifically comprises calculating a position according to the contact range of the contact point at the sampling time point that is before the second time period, and determining the position obtained by calculation as the position at which the contact point leaves the touchscreen.

5. The method according to claim 2, wherein the determining the second track information comprises:
acquiring, from the first track information and when the first track information comprises the information about the position at each sampling time point and the contact range at each sampling time point, a contact range at each sampling time point in a second time period that is before the contact point leaves the touchscreen, and using a contact range of the contact point at a sampling time point that is before the second time period as the second track information that is before the process in which the contact point leaves the touchscreen; and
wherein the positioning the position at which the contact point leaves the touchscreen comprises determining a position corresponding to the contact range of the contact point at the sampling time point that is before the second time period as the position at which the contact point leaves the touchscreen.

6. A touch positioning apparatus, wherein the apparatus comprises:
a processor; and
a non-transitory computer readable medium connected to the processor and having stored thereon instructions for causing the processor to:
record first track information about moving of a contact point on a touchscreen;
determine, from the first track information, second track information that is before a process in which the contact point leaves the touchscreen; and
position, according to the second track information, a position at which the contact point leaves the touchscreen.

7. The apparatus according to claim 6, wherein the first track information comprises at least one of information about a position at each sampling time point when the contact point moves on the touchscreen and a contact range at each sampling time point when the contact point moves on the touchscreen.

8. The apparatus according to claim 7, wherein the first track information comprises the information about the position at each sampling time point; and
wherein the non-transitory computer readable medium further has stored thereon instructions for causing the processor to:
acquire, from the first track information, information about a position at each sampling time point in a first time period that is before the contact point leaves the touchscreen, and using information about a position of the contact point at a sampling time point that is before the first time period as the second track information that is before the process in which the contact point leaves the touchscreen; and
determine the position of the contact point at the sampling time point that is before the first time period as the position at which the contact point leaves the touchscreen, wherein the position of the contact point at the sampling time point that is before the first time period is determined.

9. The apparatus according to claim 7, wherein the first track information comprises the contact range at each sampling time point; and
wherein the non-transitory computer readable medium further has stored thereon instructions for causing the processor to:
acquire, from the first track information, a contact range at each sampling time point in a second time period that is before the contact point leaves the touchscreen, and using a contact range of the contact point at a sampling time point that is before the second time period as the second track information that is before the process in which the contact point leaves the touchscreen;
calculate a position according to the contact range of the contact point at the sampling time point that is before the second time period; and
determine the position obtained by calculation as the position at which the contact point leaves the touchscreen, wherein the contact range of the contact point at the sampling time point that is before the second time period is determined.

10. The apparatus according to claim 7, wherein the first track information comprises the information about the position at each sampling time point and the contact range at each sampling time point;
wherein the non-transitory computer readable medium further has stored thereon instructions for causing the processor to:
acquire, from the first track information, a contact range at each sampling time point in a second time period that is before the contact point leaves the touchscreen, and use a contact range of the contact point at a sampling time point that is before the second time period as the second track information that is before the process in which the contact point leaves the touchscreen; and
determine a position corresponding to the contact range of the contact point at the sampling time point that is before the second time period as the position at which the contact point leaves the touchscreen, wherein the contact range of the contact point at the sampling time point that is before the second time period is determined.

11. A touchscreen terminal, wherein the touchscreen terminal comprises:
a bus;
a touchscreen;
a memory; and
a processor;
wherein the memory, the touchscreen and the processor are connected by the bus;
wherein the processor is configured to store, in the memory, first track information about moving of a contact point on the touchscreen; and
wherein the processor is configured to determine, from the first track information recorded by the memory, second track information that is before a process in which the contact point leaves the touchscreen, and position, according to the second track information, a position at which the contact point leaves the touchscreen.

12. The touchscreen terminal according to claim 11, wherein the first track information recorded by the memory comprises information about a position at each sampling time point when the contact point moves on the touchscreen;
wherein the processor is further configured to acquire, from the first track information stored in the memory, information about a position at each sampling time point in a first time period that is before the contact point leaves the touchscreen; and
wherein the processor is further configured to determine a position of the contact point at a sampling time point that is before the first time period as the position at which the contact point leaves the touchscreen.

13. The touchscreen terminal according to claim 11, wherein the first track information stored in the memory comprises a contact range at each sampling time point when the contact point moves on the touchscreen;
wherein the processor is further configured to acquire, from the first track information stored in the memory, a contact range at each sampling time point in a second time period that is before the contact point leaves the touchscreen;
wherein the processor is further configured to calculate a position according to a contact range of the contact point at a sampling time point that is before the second time period; and
wherein the processor is further configured to determine the position obtained by calculation as the position at which the contact point leaves the touchscreen.

14. The touchscreen terminal according to claim 11, wherein the first track information stored in the memory comprises information about a position at each sampling time point and a contact range at each sampling time point when the contact point moves on the touchscreen;
wherein the processor is further configured to acquire, from the first track information recorded by the memory, a contact range at each sampling time point in a second time period that is before the contact point leaves the touchscreen; and
wherein the processor is further configured to determine a position corresponding to a contact range of the contact point at a sampling time point that is before the second time period as the position at which the contact point leaves the touchscreen.
